(19) United States
(12) Patent Application Publication
(10) Pub. No.: US 2009/0088516 A1
(43) Pub. Date: Apr. 2, 2009

(54) METHOD TO IMPROVE THE COLOR ACCEPTANCE OF VISCOSITY STABILIZED LATEX PAINTS

(76) Inventors: Chunzhao Li, Hightstown, NJ (US); Wilbur Mardis, Holland, PA (US); Mark Gregory Matyi, JR., Wrightstown, NJ (US); Richard Henderson, Clarksburg, MD (US); Fred Ferry, Flemington, NJ (US)

Correspondence Address: MORGAN, LEWIS & BOCKIUS LLP, 1701 MARKET STREET, PHILADELPHIA, PA, 19103-2921, US

(21) Appl. No.: 12/243,775

(22) Filed: Oct. 1, 2008

Related U.S. Application Data
(60) Provisional application No. 60/976,590, filed on Oct. 1, 2007.

(51) Int. Cl. C09B 67/00

(52) U.S. Cl. 524/502

(57) ABSTRACT

A system and method to improve the color acceptance of color viscosity stabilized latex paints. The system includes a base paint, 0.05 wt % to 5 wt % of a color viscosity stabilizing compound; a colorant compound, and; a sufficient amount of a hydrophobically modified alkali swellable emulsion (“HASE”) thickener to improve the color acceptance properties of the paint, which amount is typically 0.02 wt % to 0.5 wt % of the paint, and optionally, 0.1 wt % to 5 wt % of a condensation polymer associative thickener including polyether polyurethanes, polyether polyols, polyether polyacetals, and polyether aminoplasts. The system demonstrates improved color acceptance as measured by rub-ups and ΔE values.

### RELATED APPLICATIONS

This application claims priority to U.S. Provisional Patent Application 60/976,590, filed Oct. 1, 2007, which is herein incorporated by reference in its entirety. This application is related to U.S. patent application Ser. No. 11/517,692, filed Sep. 7, 2006, and Ser. No. 11/810,935, filed Jun. 7, 2007 each of which is herein incorporated by reference in its entirety.

### BACKGROUND

Associative thickeners are known in the art to impart improved flow and leveling to latex coatings, also known as emulsion paints and coatings. It is believed that the associative thickeners function by forming reversible networks throughout a coating formulation via hydrophobic interactions with pigment, filler, latex resin, and other particles and via micellar interactions. It is also known that this thickening mechanism, and therefore paints formulated with these thickeners, often react poorly to addition of surfactants as may be encountered by addition of colorants such as point-of-sale custom colors. The addition of the colorants often results in large decreases in viscosity. Similar viscosity losses also occur in associatively thickened coatings formulated with water reducible, water dispersible and water soluble resins. It is speculated that surfactants such as are found in colorants may disrupt the reversible network formed by the hydrophobically modified theological additives, which network is responsible for the thickening. This results in large decreases in viscosity. Colorants with high levels of surfactants and wetting agents, and/or high loadings of colorants both exacerbate the viscosity losses.

Maintaining the viscosity is an important condition for a satisfactory paint. Paints are frequently used because of the aesthetic properties they impart to the substrates to which they are applied. It has been discovered that the additives which are useful for stabilizing the viscosities of the aqueous paints in which they are used may cause undesirable behaviors such as flocculation, pigment floating or other behaviors which affect the color tint, color strength and/or color uniformity of the applied paint.

Recently, several color viscosity stabilizing coatings additives (“CVS”) and associative thickeners have been introduced which are intended to counter this viscosity loss effect. While these CVS materials are effective in reducing the viscosity losses upon colorant addition, the CVS materials may reduce color acceptance, which results in color shift; that is, the color of the applied paint is lighter or darker than that of the paint without these CVS thickeners and/or additives. It has been observed for paint system containing the CVS associative thickeners and/or additives that the color may be changed by shearing of the applied film such as by rubbing the film with a finger, or shearing with a brush or roller during application. This may result in color variations across the surface to which the coating is applied which is generally considered undesirable.

The present invention addresses the problems of color acceptance in viscosity stabilized paints.

### SUMMARY

The present invention relates to a water-borne paint system, comprising a base paint and a colorant. A base paint may includes a color viscosity stabilizing compound and a hydrophobically modified alkali swellable emulsion thickener.

In some embodiments, the color viscosity stabilizing compound includes an ABLBA polymer and/or an ABCBA polymer. In some embodiments, the A component contains a hydrophobic group A, the B component is a hydrophilic polymer B, and the L component is a linking group. In some embodiments, the A component is derived from an alcohol including linear C₁₀-C₃₆ alcohols, branched C₁₂-C₃₆ alcohols, cyclic C₁₀-C₃₆ alcohols and mixtures thereof; the B component includes a polyethylene oxide polymer or a polyethylene oxide-polypropylene oxide copolymer; and the L component is selected from one or more of the following linking units: a dianhydride unit, a diisocyanate unit, an ether linkage or other difunctional moiety or difunctional radical having 1 to 22 carbon atoms. In some embodiments, the A component is derived one or more of the following: linear C₁₀-C₂₂ alcohols, branched C₁₂-C₂₄ alcohols, cyclic C₁₀-C₂₂ alcohols and mixtures thereof. In some embodiments, the A component is derived one or more of the following: linear C₁₀-C₁₈ alcohols, branched C₁₀-C₁₈ alcohols, cyclic C₁₀-C₁₈ alcohols and mixtures thereof. The A component may be derived from one or more of the following: 2-butyl-1-octanol, 2-hexyl-1-decanol, 2-octyl-1-dodecanol, 2-isoheptyl-7-methyl-undecanol, 2-(2,4,4-trimethylbutyl)-6,8,8-trimethyl-nonanol, dodecanol, tetradecanol, hexadecanol, octadecanol, tristyrylphenol, a Geurbet alcohol having an average of 14 carbon atoms and mixtures thereof.

In some embodiments, the polyethylene oxide polymer has from 25 to 100 ethylene oxide repeat units. In some embodiments, the polyethylene oxide-polypropylene oxide copolymer has a total number of repeat units ranging from 25 to 75 and up to 10 propylene oxide units. In certain embodiments, the polyethylene oxide-polypropylene oxide copolymer has a number average molecular weight less than 4400.

In some embodiments, the paint system includes a hydrophobically modified alkali swellable emulsion thickener including the reaction product of vinyl acetate, methyl methacrylate, methacrylic acid and tristyrylphenol polyethoxy ethyl methacrylate.

In certain embodiments, the linking unit is a diisocyanate linking unit. In some embodiment, the diisocyanate linking unit is selected from the group consisting of. hexamethylene diisocyanate, trimethyl hexamethylene diisocyanate, isophorone diisocyanate, tetramethyl xylylene diisocyanate, and 4,4-methylene bis(cyclohexylisocyanate).

The paint system of some embodiments includes an ABLBA polymer where the A component is derived from 2-hexyl-1-decanol, a B component including polyethylene oxide having 50 ethylene oxide units, and an L component comprising hexamethylene diisocyanate. In some embodiments of paint systems having the ABLBA polymer, the A component is a lauryl alkoxy group, the B component is polyethylene oxide having 50 to 70 ethylene oxide units and the L component comprises hexamethylene diisocyanate. In some embodiments of paint systems having the ABLBA polymer, the A component is derived from dodecanol, the B component comprises polyethylene oxide having 50 to 70 ethylene oxide units and the L component is hexamethylene diisocyanate.

According to certain embodiments, the ABCBA polymer comprises an A component comprising a hydrophobic group A, a B component comprising a hydrophilic polymer B, and a C component comprising a hydrophobic low molecular weight difunctional radical C. In some embodiments, the ABCBA polymer further comprises an L component linking the B and C components. In some embodiments, the ABCBA polymer comprises an A component derived from an alcohol including linear C₁₀-C₃₆ alcohols, branched C₁₂-C₃₆ alcohols, cyclic C₁₀-C₃₆ alcohols and mixtures thereof, a B component comprising a polyethylene oxide polymer or a polyethylene oxide-polypropylene oxide copolymer; a C component selected from the group of diols consisting of hydrophobic low molecular weight linear, branched or cyclic alkyl diols which may also contain heteroatoms such as O, N, or S; and an L component selected from one or more of the following linking units: a dianhydride unit, a diisocyanate unit, an ether linkage or other difunctional moiety or difunctional radical having 1 to 22 carbon atoms.

According to certain embodiments, the ABCBA polymer comprises an A component derived from an alcohol including linear C₁₀-C₃₆ alcohols, branched C₁₂-C₃₆ alcohols, cyclic C₁₀-C₃₆ alcohols and mixtures thereof, a B component comprising poly(ethylene glycol), and a C component selected from the group of diols consisting of ethylene glycol, propylene glycol, and 1,2-dodecanediol; and the L component selected from one or more of the following linking units: a dianhydride and a disocyanate unit.

In some embodiments, the ABCBA polymer comprises an A component derived from an alcohol including linear C₁₀-C₃₆ alcohols, branched C₁₂-C₃₆ alcohols, cyclic C₁₀-C₃₆ alcohols and mixtures thereof, a B component comprising poly(ethylene glycol), and a C component selected from the group of diols consisting poly(tetrahydrofuran), poly(caprolactone) and poly(carbonate); and the L component selected from one or more of the following linking units: a dianhydride and a disocyanate unit. In some embodiments, the L linking unit comprises one or more of the following: a urethane linking unit; an ester linking unit; an amide linking unit; a urea linking unit; an ether linkage; or other difunctional moiety or difunctional radical having 1 to 22 carbon atoms. In some embodiments, the linking units comprise urethane links obtained from compounds selected from the group consisting of hexamethylene diisocyanate, trimethyl hexamethylene diisocyanate, isophorone diisocyanate, tetramethyl xylylene diisocyanate, and 4,4-methylene bis(cyclohexylisocyanate).

According to some embodiments, the base paint comprises a resin. In some embodiments, the resin comprises one or more of the following: a vinyl acrylic resin, a vinyl acetate ethylene resin, an acrylic resin and a styrene acrylic resin. In certain embodiments, the resin has a particle size greater than 200 nm. In some embodiments, the resin has a particle size less than 200 nm.

In some embodiments, the paint system includes at least one associative thickener. The associative thickener may include at least one condensation polymer associative thickener. In some embodiments, an associative thickener comprises a mid shear associative thickener. In some embodiments, an associative thickener comprises a high shear associative thickener.

According to some embodiments, a paint system includes a film forming binder resin. In some embodiments, the film forming binder resin includes an emulsion resin, a water dispersible resin, and/or a water soluble resin.

According to certain embodiments, a paint system further includes a diluent.

In some embodiments, a paint system includes about 0.05 wt % to about 5 wt % as active polymer of the color viscosity stabilizing compound. In some embodiments, the paint system includes about 0.02 wt % to about 0.5 wt % as active polymer of the hydrophobically modified alkali swellable emulsion thickener. In some embodiments, the paint system includes about 0.1 wt % to about 5 wt % of the condensation polymer associative thickener. In some embodiments, a hydrophobically modified alkali-swellable emulsion thickener is comprised of a tristyrylphenol-containing monomer.

According to some embodiments of the present invention, a method of improving the color acceptance of color viscosity stabilized latex paints, as measured by rub-ups and/or ΔE values, includes use of a minor amount of a hydrophobically modified alkali-swellable emulsion thickener in combination with a color viscosity stabilizing additive and, optionally, another associative thickener. In some embodiments, the hydrophobically modified alkali-swellable emulsion thickener is comprised of a tristyrylphenol-containing monomer.

### DETAILED DESCRIPTION OF THE EMBODIMENTS

We have now unexpectedly discovered that aqueous coatings with excellent in-can stability and application properties that simultaneously provide excellent color viscosity stability and excellent color acceptance may be formulated by using a combination of a color viscosity stabilizing additive together with minor amounts of select hydrophobically modified alkali swellable thickeners (HASEs).

The present invention relates to a water-borne paint system having improved viscosity stability and color acceptance properties. Systems and methods of some embodiments of the present invention achieve simultaneous good color acceptance and viscosity stability in aqueous paints formulated with associative thickeners and to which a predispersed colorant is added. By improved viscosity stability, we mean that the Stormer viscosity of a base paint formulated to 90-110 Krebs Units (KU) changes by less than about 20 KU, in some embodiments less than about 15 KU, and in some embodiments by less than about 10 KU, upon addition of 12 ounces per gallon of a colorant as described below. Improved viscosity stability is independent of the direction of change in viscosity upon colorant addition (that is, the viscosity may increase or decrease on colorant addition) or the specific identity of colorant used. Improved color acceptance or rub-up means that the ΔE for the inventive paint is less than the ΔE for paint with a CVS but without a HASE thickener. In some embodiments, the change in color of a water-borne paint system is less than about 0.8 ΔE, in some embodiments less than about 0.5 ΔE, and in some embodiments negligible versus a control paint formulated without either a color viscosity stabilizer or HASE thickener to 90-110 KU.

In some embodiments of the invention, a paint system includes a base paint and a colorant compound. A base paint may include one or more film forming binder resins, diluents, color viscosity stabilizing (“CVS”) compound, hydrophobically modified alkali swellable emulsion (“HASE”) thickener, and optionally, other additives, including but not limited to wetting agents, surfactants, solvents, and other rheology control agents, pH adjusting agents, anti-skinning agents, pigments and fillers, humectants, anti-freezes, driers, crosslinking agents, and the like. The components are described in more detail herein.

### Alkali Swellable Emulsion Thickeners (“ASE”)

The systems and methods of the present invention include a base paint including a hydrophobically modified ASE (“HASE”). ASEs are well known in the art. ASEs are typically addition copolymers of vinyl unsaturated monomers such as vinyl esters and/or (meth)acrylate monomers. Such ASEs may be comprised of about 25 wt % to about 50 wt % of one or more acidic monomers, such as, for example, acrylic acid, methacrylic acid and itaconic acid. ASEs may be supplied as low viscosity emulsions. However, upon neutralization of the acidic functions, the emulsion particles may swell and ultimately untangle due to ionic repulsion of the neutralized acid moieties. The great expansion in volume and further entanglement of the high molecular weight polymer chains may lead to thickening of the aqueous system into which they are formulated. HASEs may be similar except that they may additionally include of one or more monomers having a hydrophobic radical attached to a hydrophilic polymer bridging the polymer backbone and the hydrophobic radical. Examples of such monomers may include but are not limited to lauryloxy polyoxyethyl ethyl acrylate, lauryloxy polyoxyethyl ethyl methacrylate, stearyloxy polyoxyethyl ethyl acryl ate, stearyloxy polyoxyethyl ethyl methacrylate, tristyrylphenol polyoxyethyl ethyl acrylate, and tristyrylphenol polyoxyethyl ethyl methacrylate. Such hydrophobe-containing monomers are commonly known as surfactant modified monomers, since the alcoholic radical of the vinyl monomer is similar to a nonionic surfactant in structure. One example of a suitable HASE thickener may include RHEOLATE 425 from Elementis Specialties, Inc., which comprises tristyrylphenol polyoxyethylene ethyl methacrylate. Another example may include an emulsion polymer of ethyl acrylate, methacrylic acid, methyl methacrylate and C16/C18 polyoxyethylene methacrylate.

The formulations of some embodiments of this invention may contain colorant viscosity stable thickeners and/or colorant viscosity stable additives combined with HASE thickeners. Color viscosity stable thickeners are thickeners which impart colorant stable viscosities to the coatings in which they are formulated. Color viscosity stable additives are additives which can be used with non-color stable thickeners to impart color stable viscosities to the aqueous system in which they are formulated. In some embodiments, a suitable HASE thickener includes a substituted phenol hydrophobe. In certain embodiments, a suitable HASE thickener includes tristyrylphenol as a hydrophobe.

In some embodiments, a paint system includes a HASE thickener with a tristyrylphenol modified monomer (“TSP-HASE”). Such monomer may include an average of about 15 to about 50 mols of ethylene oxide units joining a tristyrylphenoxy radical to the TSP-HASE polymer chain. Such monomers include but are not limited to tristyrylphenol polyoxyethylene ethyl acrylate, tristyryl phenol polyoxyethylene ethyl methacrylate, and 3-tristyrylphenol polyoxyethylene propene, each having an average of about 15 to about 50 repeat units of ethylene oxide. Commercial embodiments of these monomers may be mixtures comprising mono-, di- and tri-styrylphenyl radicals, and are fully functional in some embodiments of the present invention. Likewise, commercial embodiments of these monomers may be comprised of a distribution of ethylene oxide repeat units, and are fully functional in some embodiments of this invention as long as the average number of ethylene oxide units is between about 15 and about 50. In some embodiments, the TSP-HASE thickener includes tristyrylphenol modified monomer having ethylene oxide units joining a tristyrylphenyl radical to the HASE backbone polymer chain; or tristyrylphenol modified monomer having propylene oxide units joining a tristyrylphenyl radical to the TSP-HASE backbone polymer chain; or tristyrylphenol modified monomer having both ethylene oxide units joining a tristyrylphenyl radical to the TSP-HASE backbone polymer chain and propylene oxide units joining a tristyrylphenyl radical to the TSP-HASE backbone polymer chain; or tristyrylphenol modified monomer having both ethylene oxide and propylene oxide units as random or block copolymers joining a tristyrylphenyl radical to the TSP-HASE backbone polymer chain. In certain embodiments, the TSP-HASE thickener is the reaction product of vinyl acetate, methacrylate, methacrylic acid and tristyrylphenol polyethoxy [25] ethyl methacrylate. The preparation of a TSP-HASE is described in European Patent No. EP0705852, which is incorporated herein in its entirety.

In some embodiments, a base paint includes a sufficient amount of a HASE thickener to improve the color acceptance properties of the paint. In some embodiments, a base paint includes about 0.02 wt % to about 0.5 wt % as active polymer of the HASE thickener, about 0.02 wt % to about 0.2 wt % as active polymer of the HASE thickener, or about 0.1 wt % to about 0.2 wt % as active polymer of the HASE thickener. The phrase “active polymer” may be defined as the property imparting portion of the nonvolatile content of an additive.

### Color Viscosity Stabilizing Compound

A base paint of some embodiments of the present invention includes a CVS compound. Such compounds are described in U.S. patent application Ser. No. 11/517,692, filed Sep. 7, 2006, and Ser. No. 11/810,935, filed Jun. 7, 2007 each of which is herein incorporated by reference in its entirety.

In one embodiment, the CVS compound includes an ABLBA polymer. In certain embodiments, the color viscosity stabilizing compound includes an ABCBA polymer. CVS compositions are also disclosed in: U.S. Patent Appl. Publ. No. 2007/0155880; U.S. Patent Appl. Publ. No. 2006/0205630; U.S. Patent Appl. Publ. No. 2006/0106153; U.S. Patent Appl. Publ. No. 2005/0150418; and EP1208147 each of which is incorporated herein in its entirety. A base paint of some embodiments of the invention includes a sufficient amount of the CVS compound to stabilize the viscosity of the paint upon addition of a colorant. In some embodiments, a base paint includes about 0.05 wt % to about 5 wt % as active polymer of a CVS compound, about 0.1 wt % to about 1 wt % as active polymer of a CVS compound, or about 0.25 wt % to about 0.75 wt % as active polymer of a CVS compound.

In some embodiments, the CVS compound includes an ABLBA polymer wherein the A component includes a hydrophobic group A; a B component comprising a hydrophilic polymer B; and an L component including a linking group. In certain embodiments, the CVS compound includes an ABCBA polymer wherein the A component includes a hydrophobic group A, the B component includes a hydrophilic polymer B, and the C component includes a low molecular weight hydrophobic C compound. In some embodiments, these polymers further comprise an L linking group component linking the B and C components. In some embodiments, the hydrophobic group A component, of the ABLBA or ABCBA polymer, includes a C₁₀ to C₃₆ oxy-radical and may include oxy-radicals from an alkyl group; an aryl group; an aralkyl group; a substituted phenolic group, tristyrylphenol; cyclic hydrocarbon groups; an alkyl aryl group, or combinations thereof. In certain embodiments, the hydrophobic group A component is derived from an alcohol including linear C₁₀-C₃₆ alcohols, branched C₁₂-C₃₆ alcohols and mixtures thereof. In certain embodiments, the hydrophobic group A component is derived from an alcohol including linear C₁₀-C₂₄ alcohols, branched C₁₂-C₂₄ alcohols and mixtures thereof. In certain embodiments, the hydrophobic group A component is derived from an alcohol including linear C₁₀-C₁₈ alcohols, branched C₁₂-C₁₈ alcohols and mixtures thereof. In certain embodiments, the hydrophobic group A component is derived from 2-butyl-1-octanol, 2-hexyl-1-decanol, 2-octyl-1-dodecanol, 2-isoheptyl-7-methyl-undecanol, 2-(2,4,4-trimethylbutyl)-6,8,8-trimethyl-nonanol, tristyrylphenol, a Geurbet alcohol having an average of 14 carbon atoms, and mixtures thereof. In certain embodiments, the hydrophobic group A component is derived from lauryl(dodecyl)alcohol, tetradecanol, hexadecanol octadecanol, or mixtures thereof. In certain embodiments, the hydrophobic group A component is derived from 2-hexyl-1-decanol. In some embodiments, the hydrophobic group A is dodecoxylate (C₁₂). In some embodiments, the hydrophobic group A comprises tetradecoxylate. The hydrophobic group A may also comprise hexadecoxylate. In certain embodiments, the hydrophobic group A is derived from tristyrylphenol. Mixtures of any of the above may also be used and constitute further embodiments.

In some embodiments, the CVS compound includes an ABLBA polymer wherein the A component is a hydrophobic group A; a B component comprising a hydrophilic polymer B; and an L component including a linking group. In certain embodiments, the CVS compound includes an ABCBA polymer wherein the A component is a hydrophobic group A, the B component includes a hydrophilic polymer B, and the C component includes a low molecular weight hydrophobic C compound. In some embodiments, these polymers further comprise an L linking group component linking the B and C components. In some embodiments, the hydrophobic group A component, of the ABLBA or ABCBA polymer, includes a C₁₀ to C₃₆ oxy-radical and may include an oxy-radical from an alkyl group; an aryl group; an aralkyl group; a substituted phenolic group, tristyrylphenol; cyclic hydrocarbon groups; an alkyl aryl group, or combinations thereof. In certain embodiments, the hydrophobic group A component is derived from an alcohol including linear C₁₀-C₃₆ alcohols, branched C₁₂-C₃₆ alcohols, cyclic C₁₂-C₃₆ alcohols and mixtures thereof. In certain embodiments, the hydrophobic group A component is derived from an alcohol including linear C₁₀-C₂₄ alcohols, branched C₁₂-C₂₄ alcohols, cyclic C₁₂-C₂₄ alcohols and mixtures thereof. In certain embodiments, the hydrophobic group A component is derived from an alcohol including linear C₁₀-C₁₈ alcohols, branched C₁₂-C₁₈ alcohols, cyclic C₁₂-C₁₈ alcohols and mixtures thereof. In certain embodiments, the hydrophobic group A component is derived from 2-butyl-1-octanol, 2-hexyl-1-decanol, 2-octyl-1-dodecanol, 2-isoheptyl-7-methyl-undecanol, 2-(2,4,4-trimethylbutyl)-6,8,8-trimethyl-nonanol, tristyrylphenol, a Geurbet alcohol having an average of 14 carbon atoms, and mixtures thereof. In certain embodiments, the hydrophobic group A component is derived from lauryl(dodecyl) alcohol, tetradecanol, hexadecanol octadecanol, or mixtures thereof. In certain embodiments, the hydrophobic group A component is derived from 2-hexyl-1-decanol. In some embodiments, the hydrophobic group A is dodecoxylate (C₁₂). In some embodiments, the hydrophobic group A is tetradecoxylate. The hydrophobic group A may also be hexadecoxylate. In certain embodiments, the hydrophobic group A is derived from tristyrylphenol. Mixtures of any of the above may also be used and constitute further embodiments.

In other embodiments of the ABLBA and ABCBA polymers, the hydrophobic radicals are supplied by, e.g., carboxylic acids, amines, epoxides, ethers, isocyanates, and other moieties which are covalently bonded to B.

In some embodiments, the B component of the ABLBA and ABCBA polymers includes a polyethylene oxide polymer or a polyethylene oxide-polypropylene oxide copolymer, hereinafter designated polyoxyalkylene chains. In certain embodiments, the polyethylene oxide polymer has from about 25 to about 100 ethylene oxide repeat units. In certain embodiments, the polyethylene oxide-polypropylene oxide copolymer has a total number of repeat units ranging from about 25 to about 75 and up to about 10 propylene oxide units. In some embodiments, the B component includes polyethylene oxide having about 65 ethylene oxide units. In certain embodiments, the B component includes polyethylene oxide having about 50 ethylene oxide units.

In some embodiments, the polyoxyalkylene chains have a number average molecular weight of up to about 4400. In another embodiment, the polyoxyalkylene chains have a number average molecular weight of up to about 3500. In yet another embodiment, the polyoxyalkylene chains may have a number average molecular weight of up to about 2500. In some embodiments, the polyoxyalkylene chains have a number average molecular weight between about 1100 and about 4400. In some embodiments, the polyoxyalkylene chains have a number average molecular weight between about 1100 and about 3500. In some embodiments, the polyoxyalkylene chains have a number average molecular weight between about 2500 and about 4400.

In certain embodiments, the ABLBA polymer includes linking units L. In some embodiments, the ABCBA block copolymer contains at least two linking units L, one each between the B and C components; i.e., ABLCLBA. In some embodiments, L comprises a polyfunctional linking radical having 2 to 5 valences. In some embodiments, L comprises a difunctional linking radical.

In certain embodiments, the linking unit includes a diisocyanate linking unit where the unit is generated from linking compounds such as hexamethylene diisocyanate (“HDI”), trimethyl hexamethylene diisocyanate (“TMDI”), isophorone diisocyanate (“IPDI”), tetramethyl xylylene diisocyanate (“TMXDI”), and 4,4′-methylene bis(cyclohexylisocyanate). In some embodiments, the diisocyanate linking unit is generated from hexamethylene diisocyanate. For reactions using diisocyanate linking compounds, a catalyst such as an organo-tin or bismuth ester or an amine may be added to accelerate the reaction at the desired temperature. The reactions may be conducted under conditions to minimize branching and/or side reactions. In certain embodiments, reactants and/or conditions are selected to enhance branching, such as by the use of hexamethylene diisocyanate trimer, sold commercially as Desmodur N3600, a product of Bayer.

In some embodiments, the linking unit includes a dianhydride unit. In certain embodiments, the dianhydride is comprised of compounds such as benzophenone tetracarboxylic dianhydride (BTD) or pyromellitic dianhydride (PMA) which react with hydroxyl bearing compounds to give the corresponding diester polymers. For reactions using dianhydride linking compounds, an amine such as triethylamine or DABCO may be used as a catalyst. The resulting polymers may have an anionic nature to theme which can be useful in some applications.

In some embodiments, the L component includes an ether linkage or other difunctional moiety or difunctional radical having 1 to 22 carbon or equivalent atoms in a chain. Equivalent in this sense may be understood to mean di- and higher valency atoms which may bond with other atoms to form a chain. Such atoms may include carbon, oxygen, nitrogen and sulfur.

In some embodiments, the C-component includes a low molecular weight linear, branched and cyclic alkyl diols which preferably are hydrophobic and may also contain heteroatoms such as O, N, or S. In certain embodiments, the C-component includes a hydrophobic low molecular weight water insoluble diol polymers such as poly(tetrahydrofuran), poly(caprolactone), poly(tetrahydrofuran carbonate), poly(carbonate), poly(ethylene-co-1,2-butylene), poly(propylene oxide) and poly(methylene). In another embodiment, diols such as ethylene glycol, propylene glycol, butanediol, 2-butyl-2-ethyl-1,3-propanediol, 1,12-dodecanediol. In some embodiments where the C component includes 1,2-dodecanediol, the A- and B-components are adjusted to produce a polymer which can self-disperse in water. The molecular weight of the C-component may also be important and may be balanced against the molecular weight of the B-component so as to create a material with the desired level of solubility. Generally, the higher the number average molecular weight of the C-component, the more insoluble the viscosity stabilizer additive. In some embodiments, the C-component has number average molecular weights ranging from about 60 to about 1000. In some embodiments, the C-component has number average molecular weights ranging from about 90 to about 1000.

In some embodiments, the ABLBA or ABCBA polymer has number average molecular weight below about 10,000 g/mole. In some embodiments, the ABLBA or ABCBA polymer has a number average molecular weight less than 7,000 g/mole. In some embodiments, the ABLBA or ABCBA polymer has a number average molecular weight less than 4,500 g/mole. In some embodiments, the ABLBA or ABCBA polymer has a number average molecular weight of 4,500 g/mole to 10,000 g/mole.

In some embodiments, a critical factor for viscosity stabilization is the length of the CVS polymer molecules. While not wishing to be bound by theory, these stabilizers may function by a “loops and links” mechanism. In the absence of a sufficient number or concentration of surfaces and micelles, these small molecules may form flower-like micelles wherein all the hydrophobes of a polymer molecule reside in one micelle, or tails wherein one hydrophobe of a stabilizer molecule may participate in a micelle and the other is in the continuous phase. As the concentration of surfaces and micelles increases, such as by addition of surfactants to the paint system such as by, e.g., addition of a colorant, and the distance between them decreases, these stabilizer molecules may begin to bridge between micelles (“micellar bridging”) and surfaces and in so doing may form a network.

In certain embodiments, the ABLBA copolymer is synthesized from an AB ethoxylate by reacting the A compound and the monomeric components which comprise the B components in a basic solution or in the presence of a metal catalyst. In one embodiment, the AB ethoxylate has a number average molecular weight below about 5,000 g/mole. In another embodiment, the AB ethoxylate has a number average molecular below about 2,500 g/mole. In some embodiments, the AB ethoxylate has a number average molecular weight between about 1200 g/mole and about 5,000 g/mole. The AB ethoxylate may then be reacted with a linking compound L.

In some embodiments, the block co-polymer ABCBA is synthesized using an ethoxylated alcohol for the AB-blocks, a diisocyanate for a linking unit, and a diol as the C-block. In certain embodiments, the ratio of these components (ethoxylated alcohol, diisocyanate, and diol) ranges from about 2:2:0.9 to 2:2:1.2. In some embodiments, the ratio of components is about 2:2:1. When preparing CVSs in this manner, A may include a C₁₀ to C₃₆ oxy-radical and may include a hydrophobic oxy-radical containing an alkyl group, an aryl group, an aralkyl group, a substituted phenolic group, tristyrylphenol, cyclic hydrocarbon groups or an alkyl aryl group and combinations thereof. In certain embodiments of the ABCBA copolymer, the AB block includes alkyl, aryl or alkyl-aryl ethoxylates, of the form R—O—(CH₂CH₂O)ₙ—H, a diisocyanate, and a diol C, where R—O—(CH₂CH₂O)ₙ—H contributes both the A component and the B component.

In some embodiments, the block co-polymer ABCBA is synthesized using an ethoxylated alcohol for the AB-blocks, a diisocyanate for a linking unit, and a diol as the C-block. In certain embodiments, the ratio of these components (ethoxylated alcohol, diisocyanate, and diol) ranges from about 2:2:0.9 to 2:2:1.2. In some embodiments, the ratio of components is about 2:2:1. When preparing CVSs in this manner, in some embodiments A consists of a C₁₀ to C₃₆ oxy-radical and includes a hydrophobic oxy-radical containing an alkyl group, an aryl group, an aralkyl group, a substituted phenolic group, tristyrylphenol, cyclic hydrocarbon groups or an alkyl aryl group and combinations thereof. In certain embodiments of the ABCBA copolymer, the AB block has A moieties consisting of alkyl, aryl or alkyl-aryl ethoxylates, of the form R—O—(CH₂CH₂O)ₙ—H, a diisocyanate, and a diol C, where R—O—(CH₂CH₂O)ₙ—H contributes both the A component and the B component.

### Resin Film Forming Binders

A base paint formulation of some embodiments of the present invention includes one or more resin film forming binders. A binder, or resin, is the actual film forming component of paint. It is an essential component of a base paint; and other components listed herein are included optionally, depending on the desired properties of the cured film. Binders can be categorized according to drying, or curing mechanism. The four most common are simple solvent evaporation, oxidative crosslinking, catalyzed polymerization, and coalescence.

In some embodiments, the resin binder is a water dispersible resin, such as a water dispersible alkyd or a water dispersible polyurethane. In some embodiments, the resin binder is a water soluble resin. In certain embodiments, the resin binder is an emulsion resin, such as is typically used to manufacture latex paints. In certain embodiments, the resin includes a hydrophobic resin. Representative hydrophobic emulsion resins may include an acrylic resin, a styrene acrylic resin or a styrene resin. Representative examples of hydrophilic emulsion resins may include a vinyl acrylic resin or a vinyl acetate ethylene resin. In certain embodiments, the resin has a substantially spherical shape and a large particle size or low surface area. In one embodiment, the particle size may be greater than about 200 nm. In a further embodiment, the particle size ranges from about 220 nm to about 650 nm. In certain embodiments, the resin has a substantially spherical shape and small particle size or high surface area. In one embodiment, the particle size may be less than about 200 nm. In a further embodiment, the particle size ranges from about 80 nm to about 180 nm. In certain embodiments, the resin has a multilobe shape. Representative resins may include Optive 130 (BASF, acrylic, 160 nm), UCAR 300 (Dow, vinyl acrylic, 260 nm), UCAR 625 (Dow, acrylic, 340 nm), Rhoplex ML-200 (Rohm & Haas, acrylic, 590 nm multilobe), and Neocryl XK-90 (DSM Neoresins, acrylic, 90 nm). In certain embodiments, combinations of resins are used to prepare the base paint.

A substantially spherical particle is defined as a particle having a roundness of at least 0.7 and sphericity of at least 0.7, as measured by the use of a Krumbien/Sloss chart using the experimental procedure recommended in International Standard ISO 13503-2, “Petroleum and Natural Gas Industries—Completion Fluids and Materials—Part 2: Measurement of Properties of Proppants Used in Hydraulic Fracturing and Gravel-Packing Operations” (First Edition, 2006), Section 7, for the purposes of this disclosure.

### Diluents

A paint system of some embodiments of the present invention includes at least one diluent. Suitable diluents may include but are not limited to water, coalescing solvents, water miscible solvents, and other liquids which are used to reduce the concentration of the non-volatile materials use in the base paint.

### Associative Thickeners

The base paint also includes at least one associative thickener. Associative thickeners are water soluble, water dispersible, or water swellable polymers that have chemically attached hydrophobic groups. In certain embodiments, a base paint includes a condensation polymer associative thickener including but not limited to polyether polyurethanes, polyether polyols, polyether polyacetals, polyether aminoplasts and the like. In some embodiments, a base paint includes about 0.05 wt % to about 5 wt % as active polymer of a condensation polymer associative thickener, about 0.1 wt % to about 3 wt % as active polymer of a condensation polymer associative thickener, or about 0.2 wt % to about 1 wt % as active polymer of a condensation polymer associative thickener.

In some embodiments, the ABLBA and ABCBA stabilizers are effective in improving the viscosity stability to colorant addition for paints containing at least one associative thickener. In certain embodiments, the associative thickeners include nonionic hydrophobically modified materials such as polyether and/or polyurethane associative thickeners or ionic associative thickeners such as hydrophobically modified alkali swellable (or soluble) emulsions (HASE) and hydrophobically modified hydroxyethyl cellulose and mixtures thereof. The number average molecular weights of the associative thickeners may range from about 10,000 to about 500,000 g/mole or more, depending on the chemical type of associative thickener. In some embodiments, the number average molecular weight of the associate thickeners may range from about 10,000 to about 50,000 g/mole. In some embodiments, the number average molecular weight of the associate thickeners may range from about 100,000 to about 300,000 g/mole. In some embodiments, the number average molecular weight of the associate thickeners may range from about 400,000 to about 800,000 g/mole or more. In certain embodiments, two associative thickener compositions may be used in combination with the ABLBA or ABCBA stabilizer. The two associative thickeners may be independently selected from polyether polyurethanes, polyether polyols, polyether polyacetals, polyether aminoplasts, and the like. In one embodiment, the two associative thickeners may both have a composition of polyether polyurethane. In another embodiment, the two associative thickeners may both have a composition of polyether polyacetal. In yet another embodiment, one associative thickener has a composition of polyether and the second associative thickener has a composition of polyether polyurethane. Representative associative thickener pairs may include Rohm & Haas Acrysol RM 825/RM 2020 NPR, Rohm & Haas Acrysol SCT 275/RM 2020 NPR, Aqualon NLS 200/NHS 300, Elementis RHEOLATE 255/350 and Cognis DSX 1514/DSX 3075. In certain embodiments, a high shear associative thickener composition may be used in combination with the ABLBA or ABCBA stabilizer. In some embodiments, a mid-shear associative thickener composition may be used in combination with the ABLBA or ABCBA stabilizer. In one embodiment, the associative thickener has a composition of hydrophobically modified polyether polyurethane. In another embodiment, the associative thickener has a composition of a hydrophobically modified polyether polyacetal. In yet another embodiment, the associative thickener has a composition of hydrophobically modified polyether. The terms high and mid shear are relative and are meant to indicate that the thickeners are particularly useful for either increasing the high shear viscosity of a coating or the mid shear viscosity of a coating. High shear viscosity of a coating is typically measured at 10,000 sec⁻¹ (the so-called ICI viscosity), which is intended to represent the viscosity of the paint during typical brush and roller application conditions. Mid shear viscosity relates to the in-can appearance and is typically measured in Krebs units (KU) using a Stormer viscometer.

In certain embodiments where the resin has a particle size less than about 200 nm, the ABLBA or ABCBA stabilizing polymers may be used in combination with a high shear thickener and act as a mid shear thickener. In certain embodiments where the resin has a particle size greater than about 200 nm, the ABLBA or ABCBA stabilizing polymers may be used in combination with a high shear thickener and a mid shear thickener.

The CVS stabilizers may be incorporated into the base paint as a solid or as a liquid solution with other solvents and surfactants. In a solid form, in one embodiment, the CVS stabilizer is added to the paint formulation with the colorant(s) and then the material is dispersed for example with a high speed disperser or on a Red Devil shaker. In a liquid form, in certain embodiments, the CVS stabilizer is added at any stage of the base paint preparation. In one embodiment, the CVS stabilizer is added to the base paint formulation.

The HASE thickeners and color viscosity stabilizers essential to this invention may be added to the base paint at any stage during the base paint making operation, in any order including simultaneously and as a mixture, and in any fashion. The HASE thickener may be added as an emulsion or as a dry powder. In one embodiment, the HASE thickener and the color viscosity stabilizer are added separately and in any order during the grind phase of preparing the base paint. In other embodiments, the HASE thickener is added as an emulsion, as a preneutralized or partially neutralized dispersion, or as a dry powder to the color viscosity stabilizer and the mixture added at any point during the base paint making process including during the grind or the letdown phases or to the fully letdown base paint.

The HASE thickener may be activated by addition of alkali at any point. Typical alkalis include alkali metal hydroxides and carbonates and organic amines. In most instances, however, the base paint contains sufficient alkali to neutralize and activate the HASE thickener.

Additional Additives

A paint system of some embodiments of the present invention may include additional components as suitable to achieve the desire effect, including but not limited to wetting agents, surfactants, solvents, and other rheology control agents, pH adjusting agents, anti-skinning agents, pigments and fillers, humectants, anti-freezes, driers, crosslinking agents, and the like.

### Colorants

A paint system of the present invention may also include a colorant. Any suitable colorant may be used in the paint formulation. In some embodiments, the colorant added to a paint system is predispersed. It is to be understood that this invention is equally effective with single colorants or mixtures of colorants.

Within the context of this invention, a colorant or colorant compound is defined as being comprised of one or more colored pigment(s) which have been dispersed in an aqueous or water-miscible medium by use of mechanical energy, i.e., grinding or shearing by means of dispersing equipment such as, for example, a ball mill and a sand mill. The dispersion process may be effected by the use of auxiliary compounds such as, for example, surfactants, wetting agents, water-miscible solvents, and dispersants, in addition to mechanical energy. Pigments which are commonly used include inorganic and organic pigments such as, for example, iron oxides, chromium oxide, phthalocyanine blue, and carbon black. The colorants are usually sold in concentrated form (typically 25% to 75% solids by weight) so that modest amounts can be used in a waterborne coating composition to provide a desired range of color intensities while not compromising the properties of the waterborne coating composition unduly. Typical amounts of colorants which are used in architectural coatings are from 2 to 4 fluid ounces of colorant per gallon of base paint for light tint bases and pastels, from 4 to 8 fluid ounces of colorant per gallon of base paint for medium tint bases, and from 8 to 16 fluid ounces of colorant per gallon of base paint for deeptone tint bases. Of course, different colorants and mixtures thereof are frequently used to provide a wide latitude in color selection. Such colorants are frequently added to a base paint at the point-of-purchase of the colored paint, such as a paint store, followed by admixing the colorant and the waterborne coating composition by various means such as shaking the can of paint.

### Methods of Use

A paint system of some embodiments of the present invention provides good color acceptance as well as improved viscosity stability in aqueous paints formulated with associated thickeners and to which a predispersed colorant is added. By improved viscosity stability, color viscosity stable, and colorant stable viscosities, we mean that the Stormer viscosity of a base paint formulated to 90-110 Krebs Units (KU) changes by less than about 20 KU, in some embodiments less than about 15 KU, and in some embodiments by less than about 10 KU upon addition of 12 fluid ounces of a colorant per gallon of base paint as described below. Improved viscosity stability may be independent of the direction of change in viscosity upon colorant addition (that is, the viscosity may increase or decrease on colorant addition) or the specific identity of colorant used. Improved color acceptance or rub-up means that the ΔE for the inventive paint is less than the ΔE for paint with a CVS but without a HASE thickener. In some embodiments, the change in color of a water-borne paint system is less than about 0.8 ΔE, in some embodiments less than about 0.5 ΔE, and in some embodiments negligible versus a control paint formulated without either a color viscosity stabilizer or HASE thickener to 90-110 KU. Some optimization of the CVS aid HASE amounts may be necessary to achieve this.

The Stormer viscosity changes are the differences between the Stormer viscosities of untinted, equilibrated base paints and the equilibrated paint systems containing the colorant(s). Base paints and paint systems are allowed to equilibrate in a constant temperature environment (typically 20-30° C.) for periods of from typically 4 to 24 hours. The paints are not disturbed while equilibrating.

Color acceptance and the value of ΔE of a finished colored aqueous formulation may be determined using the rub-up test. The ΔE measurement test is often called a “test of rubbing with the finger,” known to persons skilled in the art by the term “rub ups.” This test consists of applying the formulation of the colored finish paint to be tested onto a test chart, waiting until the paint becomes tacky, and then applying shear stress by rubbing, with the finger, the still viscous film of paint, for 60 seconds.

After the film dries, the colorimetric difference between the shear-stressed area (rubbed area) and the non-shear-stressed area (area of the non-rubbed film), determined by measuring CIELAB color coordinates L* a* b*, makes it possible to evaluate (value of ΔE) whether or not the paint composition tested has a good pigmentary compatibility. In some embodiments, it is desired that the paint composition has a ΔE of less than 0.8. In some embodiments, it is desired that the paint composition has a ΔE of less than 0.5. In some embodiments, it is desired that the paint composition has a negligible ΔE.

In some embodiments, a paint system including a hydrophobically modified alkali-swellable emulsion thickener in combination with a color viscosity stabilizing additive and, optionally, another associative thickener provides improved color acceptance of color viscosity stabilized latex paints, as measured by rub-ups and/or ΔE values.

### EXAMPLES

The following examples further describe and demonstrate illustrative embodiments within the scope of the present invention. The examples are given solely for illustration and are not to be construed as limitations of this invention as many variations are possible without departing from the spirit and scope thereof.

To test the effectiveness of these ASE, HASE and TSP-HASE thickeners in combination with the color viscosity stabilizing compound, model paint formulations were prepared. The formulation of one base is listed in Table 1. The ASE, HASE and TSP-HASE materials and the color viscosity stabilizer were added during the viscosity adjusting step. The colorants were added at a rate of 12 fluid ounces per gallon of paint.

TABLE 1
Deep Tint Low VOC Semi-Gloss with BASF Optive 130,
100 gallon formula

| | | | | Ingredient |
|---|---|---|---|---|
| Ingredient Identity | lb. | gal. | Supplier | Type |
| Grind | | | | |
| Water | 75.8 | 9.1 | | Solvent |
| Cellosize 4400 | 1.0 | 0.1 | Dow | Thickener |
| Ammonium | 2.0 | 0.3 | | Base |
| hydroxide | | | | |
| Dapro DF 7010 | 2.0 | 0.3 | Elementis | Defoamer |
| Triton CF10 | 3.5 | 0.4 | Rohm & Haas | Dispersant |
| Tamol 731 | 2.0 | 0.2 | Rohm & Haas | Surfactant |
| Ti0₂ (R706) | 25.3 | 0.8 | Dupont | TiO₂ |
| Polygloss 90 | 35.4 | 1.6 | | |
| Nuosept 95 | 1.0 | 0.1 | ISP Industries | Biocide |
| Grind Total | 148 | 12.9 | | |
| Letdown | | | | |
| Water | 45.2 | 5.4 | | |
| Optive 130 | 506.9 | 57.3 | BASF | Latex |
| Texanol | 8.0 | 1.0 | Eastman | Solvent |
| Letdown Total | 708.1 | 76.6 | | |
| Hold for Viscosity | | | | |
| Adjustment | | | | |
| Associative | See Table 2 | See | Various | Various |
| Thickeners + HASE | | Table 2 | | |
| or ASE | | | | |
| Thickener + Color | | | | |
| Stabilizing Additive | | | | |
| Water + ammonia | | As | | |
| to adjust pH to | | needed | | |
| approximately 9 | | | | |
| Totals | 903.7 | 100 | | |

The determination of the color acceptance and the value of ΔE of the finished colored aqueous formulation is performed using the rub-up test, as described below. A film of the tinted paint was drawn down with a 0.076 mm (3 mil) Bird applicator on a Leneta form 2C test chart held by a vacuum plate. The film was dried under ambient conditions and examined for rub-up test and ΔE measurements.

The ΔE measurement test is often called a “test of rubbing with the finger”, known to persons skilled in the art by the term “rub ups.” This test consists of applying the formulation of the colored finish paint to be tested onto a test chart, waiting until the paint becomes tacky, and then applying shear stress by rubbing, with the finger, the still viscous film of paint, for 60 seconds in any place whatsoever.

After the film dries, the colorimetric difference between the shear-stressed area (rubbed area) and the non-shear-stressed area (area of the non-rubbed film), determined by measuring CIELAB color coordinates L* a* b*, makes it possible to evaluate (value of ΔE) whether or not the paint composition tested has a good pigmentary compatibility.

### Example 1

To prepare a base paint as shown in Table-1, a paint grind was first made. Next, a paint letdown was prepared by combining the paint grind with Optive 130 resin, water and Texanol. The base paint was prepared by adding to the paint letdown water, an associative thickener, a HASE or ASE thickener, and a color viscosity stabilizing additive. The pH was adjusted to approximately 9.0 with ammonia. The paints were equilibrated at 25° C. for 24 hr and the Stormer and ICI viscosities were recorded and then tinted with 12 fl oz/gallon colorants. The tinted paints were then equilibrated for 24 hr and the final tinted equilibrated viscosities were recorded. To evaluate the color acceptance of the paint, a film of tinted paint was drawn down with a 0.076 mm (3 mil) Bird applicator on a Leneta form 2C test chart held by a vacuum plate.

The film was dried at room temperature and examined for rub-up test and ΔE measurements. From Table 2, the associative thickeners are Acrysol RM2020NPR and RHEOLATE 350.

TABLE 2
Effect of HASE/ASE Thickener on Color Acceptance of EA3281
in Optive 130 Paint (T-23957)

| | | | | | | | Equilibrated | |
|---|---|---|---|---|---|---|---|---|
| RHEOLATE | | | | | | | Untinted | |
| CVS-1¹ | ASE/HASE Thickener | | | ICI Builder | | | Viscosity | |
| [ ] | Name | | [ ] | Name | Type | [ ] | Krebs | ICI** |
| wt. % | (—) | Type | wt. % | (—) | — | wt. % | (KU) | (P) |
| | RHEOLATE | HASE | 1 | RM2020NPR⁶ | PEPO | 3.00 | 104 | 1.01 |
| | 425² | | | | | | | |
| | RHEOLATE | HASE | 1 | RM2020NPR | PEPO | 3.00 | 104 | 1.01 |
| | 425 | | | | | | | |
| 3 | | — | | RHEOLATE 350⁷ | PEPO | 3.00 | 99.6 | 0.99 |
| 2 | | | | RHEOLATE 350 | PEPO | 3.00 | 80 | 1.6 |
| 2 | EA3277³ | HASE | 0.45 | RHEOLATE 350 | PEPO | 3.00 | 101.2 | 1.64 |
| 2 | Acrysol TT- | HASE | 0.45 | RHEOLATE 350 | PEPO | 3.00 | 100.8 | 1.70 |
| | 935⁴ | | | | | | | |
| 2 | RHEOLATE 1⁵ | ASE | 0.45 | RHEOLATE 350 | PEPO | 3.00 | 92.6 | 1.48 |
| 2 | RHEOLATE | HASE | 0.45 | RHEOLATE 350 | PEPO | 3.00 | 101.9 | 1.75 |
| | 425 | | | | | | | |
| 3.45 | | — | | RM2020NPR | PEPU | 4.00 | 105.6 | 1.28 |
| 3 | | | | RM2020NPR | PEPU | 4 | 94 | 1.4 |
| 3 | RHEOLATE | HASE | 0.45 | RM2020NPR | PEPU | 4.00 | 118.8 | 1.6 |
| | 425 | | | | | | | |
| 3 | | — | | RHEOLATE 350 | PEPO | 3.00 | 98 | 1.72 |
| 2 | | — | | RHEOLATE 350 | PEPO | 3.00 | 80 | 1.6 |
| 2 | RHEOLATE | HASE | 0.45 | RHEOLATE 350 | PEPO | 3.00 | 101.9 | 1.75 |
| | 425 | | | | | | | |
| 2 | Acrysol TT-935 | HASE | 0.45 | RHEOLATE 350 | PEPO | 3.00 | 100.8 | 1.7 |
| 2 | EA-3277 | HASE | 0.45 | RHEOLATE 350 | PEPO | 3.00 | 101.2 | 1.64 |
| 2 | RHEOLATE 1 | ASE | 0.45 | RHEOLATE 350 | PEPO | 3.00 | 92.6 | 1.48 |
| 3.45 | | — | | RM2020NPR | PEPU | 4.00 | 106.5 | 1.29 |
| 3 | | | | RM2020NPR | PEPU | 4.00 | 94 | 1.4 |
| 3 | RHEOLATE | HASE | 0.45 | RM2020NPR | PEPU | 4.00 | 119.6 | 1.7 |
| | 425 | | | | | | | |

| | Equilibrated | | | | | | |
|---|---|---|---|---|---|---|---|
| RHEOLATE | Tinted | | | | | | |
| CVS-1¹ | Viscosity | | | | | | |
| [ ] | Krebs | ICI** | Δη | | | Rub-up | Rub-up |
| wt. % | (KU) | (P) | Krebs | ICI** | Colorant⁸ | □E | visual |
| | 79.2 | 0.63 | −24.8 | −0.38 | Lamp Black | 0.63 | None |
| | 87.0 | 0.65 | −17 | −0.36 | Phthalocyanine | 1.20 | None |
| | | | | | Blue | | |
| 3 | 92.7 | 1.93 | −6.9 | 0.94 | Lamp Black | 2.11 | Significant |
| 2 | 77.6 | 1.6 | −2.4 | 0 | Lamp Black | 2.19 | Significant |
| 2 | 94 | 1.77 | −7.2 | 0.13 | Lamp Black | 2.1 | Significant |
| 2 | 93.3 | 1.96 | −7.5 | 0.26 | Lamp Black | 1.98 | Significant |
| 2 | 90.4 | 1.67 | −2.2 | 0.19 | Lamp Black | 1.84 | Significant |
| 2 | 94.7 | 1.87 | −7.2 | 0.12 | Lamp Black | 1.08 | Slight |
| 3.45 | 91.5 | 1.77 | −14.1 | 0.49 | Lamp Black | 2.77 | Significant |
| 3 | 84.3 | 1.5 | −9.7 | 0.1 | Lamp Black | 1.84 | Significant |
| 3 | 104.2 | 1.86 | −14.6 | 0.26 | Lamp Black | 0.48 | None |
| 3 | 92 | 1.99 | −6 | 0.27 | Phthalocyanine | 1.82 | Significant |
| | | | | | Blue | | |
| 2 | 77.8 | 1.6 | −2.2 | 0 | Phthalocyanine | 2.21 | Significant |
| | | | | | Blue | | |
| 2 | 96.7 | 1.74 | −5.2 | −0.01 | Phthalocyanine | 0.81 | None |
| | | | | | Blue | | |
| 2 | 92.7 | 1.71 | −8.1 | 0.01 | Phthalocyanine | 1.61 | Slight |
| | | | | | Blue | | |
| 2 | 95.1 | 1.61 | −6.1 | −0.03 | Phthalocyanine | 0.41 | None |
| | | | | | Blue | | |
| 2 | 91 | 1.45 | −1.6 | −0.03 | Phthalocyanine | 2.13 | Moderate |
| | | | | | Blue | | |
| 3.45 | 97.3 | 1.62 | −9.2 | 0.33 | Phthalocyanine | 2.14 | Significant |
| | | | | | Blue | | |
| 3 | 90 | 1.6 | −4 | 0.2 | Phthalocyanine | 2.32 | Significant |
| | | | | | Blue | | |
| 3 | 108.5 | 1.63 | −11.1 | −0.07 | Phthalocyanine | 1.02 | None |
| | | | | | Blue | | |

Table 2 Footnotes:
¹RHEOLATE CVS-1 is a colorant viscosity stabilizer from Elementis Specialties INC.
²RHEOLATE 425 is a hydrophobically modified alkali swellable emulsion (HASE) thickener available from Elementis Specialties INC.
³EA-3277 is an experimental HASE thickener comprised of ethyl acrylate, methacrylic acid, methyl methacrylate and C₁₆/C₁₈ polyoxyethylene methacrylate.
⁴Acrysol TT-935 is a HASE thickener available from the Rohm and Haas Company.
⁵RHEOLATE 1 is an alkali swellable emulsion (ASE) thickener available from Elementis Specialties INC.
⁶[Acrysol] RM2020NPR is a hydrophobically modified polyethoxylated urethane (HEUR) associative thickener available from the Rohm and Haas Company.
⁷RHEOLATE 350 is a polyether polyol associative thickener available from Elementis Specialties INC.
⁸Lamp black is Degussa Colortrend B 888-9907; phthalocyanine blue is Degussa Colortrend E 888-7214.

As can be seen in the table above, RHEOLATE CVS-1 significantly reduces the viscosity loss on addition of a colorant as compared to the paints containing only associative and ASE/HASE thickeners. In the absence of RHEOLATE CVS-1, the viscosity drops following addition of a colorant are 17-25 KU. RHEOLATE CVS-1 thickens the paint and stabilizes the viscosity such that viscosity losses are reduced to about 1.6 to about 15 KU. However, with RHEOLATE CVS-1 and a high shear viscosity builder alone, rub-ups range from significant to moderate and ΔEs>2. Addition of minor quantities of RHEOLATE 425, a HASE thickener comprised of tristyrylphenol polyoxyethylene ethyl methacrylate from Elementis Specialties, significantly improves color acceptance and reduce ΔEs with both Lamp Black and Phthalocyanine Blue colorants, and with both PEPO and PEPU ICI builders—ΔE values were consistently at or below 1.20 as shown in Table 2. Neither of the other HASE thickeners (EA-3277 and Acrysol TT-935) are as generally beneficial, nor is the ASE thickener, RHEOLATE 1, as demonstrated by ΔE values above 1.6 for substantially all tests of these materials shown in Table 2.

A second base paint formulation was also tested as shown in Table 3.

TABLE 3
Deep Tint Eggshell Moderate VOC with Dow UCAR 625,
100 gal formula

| | | | | Ingredient |
|---|---|---|---|---|
| Ingredient Identity | lb. | gal. | Supplier | Type |
| Grind | | | | |
| Water | 75.0 | 9.0 | | Solvent |
| Nuosept 95 | 1.0 | 0.1 | ISP industries | Biocide |
| Drewplus L464 | 2.0 | 0.3 | Drew Industrial | Defoamer |
| Triton N-57 | 1.0 | 0.1 | Rohm & Haas | Surfactant |
| Tamol 731 | 7.0 | 0.8 | Rohm & Haas | Dispersant |
| TiPure R706 | 25.0 | 0.8 | Dupont | TiO₂ |
| Minex 7 | 118.0 | 5.4 | Unimin | Filler |
| Microwhite 25 | 82.0 | 3.6 | | Filler |
| Grind Total | 312 | 20.1 | | |
| Letdown | | | | |
| UCAR 625 | 400.0 | 45.4 | Dow Chemical | Latex |
| Texanol | 16.0 | 2.0 | | Coalescent |
| Ethylene Glycol | 20.0 | 2.2 | | Solvent |
| Ammonium hydroxide | 3.0 | 0.4 | | Base |
| Drewplus L464 | 2.0 | 0.3 | Drew Industrial | Defoamer |
| Letdown total | 753 | 70.4 | | |
| Hold for Viscosity | | | | |
| Adjustment | | | | |
| Associative Thickeners + | 249.0 | 28.5 | Various | Various |
| HASE or ASE | | | | |
| Thickener + Color | | | | |
| Stabilizing Additive | | | | |
| Water + Ammonia to | | As | | |
| adjust pH to approx. 9.0 | | needed | | |
| Totals | 1002 | 98.9 | | |

### Example 2

To prepare a base paint as shown in Table-3, a paint grind was first made. Next, a paint letdown was prepared by combining the paint grind with UCAR 625 resin, Texanol, ethylene glycol, ammonium hydroxide and Drewplus L464. The base paint was prepared by adding to the paint letdown water, an associative thickener, a HASE or ASE thickener, and a color viscosity stabilizing additive. The pH was adjusted to approximately 9.0 with ammonia. The paints were equilibrated at 25° C. for 24h and the Stormer and ICI viscosities were recorded and then tinted with 12 fl oz/gallon colorants. The tinted paints were then equilibrated for 24h and the final tinted equilibrated viscosities were recorded. To evaluate the color acceptance of the paint a film of tinted paint was drawn down with a 0.076 mm (3 mil) Bird applicator on a Leneta form 2C test chart held by a vacuum plate. The film was dried at room temperature and examined for rub-up test and ΔE measurements.

TABLE 4
Effect of HASE Thickener on Color Acceptance in Color Viscosity Stabilized UCAR 625 Paints (T-23954)

| Colorant | | | | | | Equilibrated | | | | | | | | |
|---|---|---|---|---|---|---|---|---|---|---|---|---|---|---|
| Viscosity | | | | | | Untinted | | Equilibrated | | | | | | |
| Stabilizer | | KU Builder | | HASE | | Viscosity | | Tinted Viscosity | | | | | | |
| Name | [ ] | Name | {] | Name | [ ] | Krebs | ICI** | Krebs | ICI** | Δη | | | Rub-up | Rub-up |
| (—) | wt. % | (—) | wt. % | (—) | wt. % | (KU) | (P) | (KU) | (P) | Krebs | ICI** | Colorant² | ΔE | visual |
| | | RM825³ | 3 | | | 91.3 | 1.21 | 70.3 | 0.93 | −21 | 0.28 | Lamp Black | 0.52 | None |
| | | RM825 | 3 | | | 91.3 | 1.21 | 82.5 | 1.23 | −8.8 | 0.02 | Phthalocyanine | 1.28 | None |
| | | | | | | | | | | | | Blue | | |
| RHEOLATE | 1.5 | RM825 | 2.75 | | | 90.2 | 1.65 | 86.7 | 1.88 | −3.5 | 0.23 | Lamp Black | 0.76 | Slight |
| CVS-1 | | | | | | | | | | | | | | |
| RHEOLATE | 1.5 | RM825 | 2.75 | RHEOLATE 425 | 0.20 | 99.2 | 1.99 | 97.5 | 2.13 | −1.7 | 0.14 | Lamp Black | 0.16 | None |
| CVS-1 | | | | | | | | | | | | | | |
| RHEOLATE | 1.3 | RM825 | 2.75 | RHEOLATE 425 | 0.20 | 98.3 | 2 | 94.2 | 1.97 | −4.1 | −0.03 | Lamp Black | 0.21 | None |
| CVS-1 | | | | | | | | | | | | | | |
| RHEOLATE | 1.1 | RM825 | 2.75 | RHEOLATE 425 | 0.40 | 103.8 | 1.98 | 98.1 | 2.08 | −5.7 | 0.1 | Lamp Black | 0.42 | None |
| CVS-1 | | | | | | | | | | | | | | |
| RHEOLATE | 1.5 | RM825 | 2.75 | | | 90.2 | 1.65 | 90.2 | 1.9 | 0 | 0.25 | Phthalocyanine | 2.23 | Significant |
| CVS-1 | | | | | | | | | | | | Blue | | |
| RHEOLATE | 1.5 | RM825 | 2.75 | RHEOLATE 425 | 0.20 | 99.2 | 1.99 | 99.6 | 2.15 | 0.4 | 0.16 | Phthalocyanine | 1.15 | Slight |
| CVS-1 | | | | | | | | | | | | Blue | | |
| RHEOLATE | 1.3 | RM825 | 2.75 | RHEOLATE 425 | 0.20 | 98.3 | 2 | 98.5 | 2.06 | 0.2 | 0.06 | Phthalocyanine | 1.11 | None |
| CVS-1 | | | | | | | | | | | | Blue | | |
| RHEOLATE | 1.1 | RM825 | 2.75 | RHEOLATE 425 | 0.40 | 103.8 | 1.98 | 104.7 | 2.18 | 0.9 | 0.2 | Phthalocyanine | 1.08 | None |
| CVS-1 | | | | | | | | | | | | Blue | | |
| EA-3280¹ | 1.5 | RM825 | 2.75 | | | 88 | 1.48 | 79.1 | 1.42 | −8.9 | −0.06 | Lamp Black | 1.66 | Moderate |
| EA-3280 | 1.5 | RM825 | 2.75 | RHEOLATE 425 | 0.20 | 95.7 | 1.7 | 89.6 | 1.8 | −6.1 | 0.1 | Lamp Black | 0.3 | None |
| EA-3280 | 1.3 | RM825 | 2.75 | RHEOLATE 425 | 0.20 | 96 | 1.58 | 87.4 | 1.53 | −8.6 | −0.05 | Lamp Black | 0.33 | None |
| EA-3280 | 1.1 | RM825 | 2.75 | RHEOLATE 425 | 0.40 | 101.9 | 1.77 | 93.7 | 1.76 | −8.2 | −0.01 | Lamp Black | 0.34 | None |
| EA-3280 | 1.5 | RM825 | 2.75 | | | 88 | 1.48 | 83.5 | 1.48 | −4.5 | 0 | Phthalocyanine | 2.43 | Significant |
| | | | | | | | | | | | | Blue | | |
| EA-3280 | 1.5 | RM825 | 2.75 | RHEOLATE 425 | 0.20 | 95.7 | 1.7 | 93 | 1.74 | −2.7 | 0.04 | Phthalocyanine | 2.52 | Moderate |
| | | | | | | | | | | | | Blue | | |
| EA-3280 | 1.3 | RM825 | 2.75 | RHEOLATE 425 | 0.20 | 96 | 1.58 | 92.5 | 1.64 | −3.5 | 0.06 | Phthalocyanine | 2.1 | Slight |
| | | | | | | | | | | | | Blue | | |
| EA-3280 | 1.1 | RM825 | 2.75 | RHEOLATE 425 | 0.40 | 101.9 | 1.77 | 99.7 | 1.83 | −2.2 | 0.06 | Phthalocyanine | 1.2 | None |
| | | | | | | | | | | | | Blue | | |

¹EA-3280 is an experimental color viscosity stabilizer according to US patent application 20070055002, the components of which are described in paragraphs [0015]-[0021]
²The colorants are the same as described above.
³[Acrysol] RM825 is a hydrophobically modified polyethoxylated urethane (HEUR) associative thickener available from the Rohm and Haas Company.

In Example 2 where the paints were formulated with Ucar 625, a large particle size acrylic resin, the colorant viscosity stabilizer provided insufficient Stormer viscosity when employed as the sole Stormer (KU) viscosity builder. A separate mid shear viscosity builder (Acrysol RM825 from Rohm & Haas) was used to achieve the desired Stormer viscosity. In the absence of the colorant viscosity stabilizer, significant viscosity losses occurred on addition of a colorant, especially the lamp black colorant (−21 KU).

Note that in all cases that include a CVS compound but not RHEOLATE 425, slight to significant rub-up occurred (showing a ΔE value of 0.76 or greater). In most cases, use of RHEOLATE 425 in combination with the colorant viscosity stabilizer mitigated the rub-ups and reduced ΔEs (showing ΔEs of 1.15 or less in all but one case). For paints formulated with 0.4% of RHEOLATE 425 and 1.1% of either RHOELATE CVS-1 or EA-3280 colorant viscosity stabilizers, no rub-up occurred and ΔEs were significantly reduced (showing ΔEs of 1.2 or less).

### Example 3

Example 3 demonstrates that pH is not the causative factor for the improved color acceptance of paints formulated with HASE thickeners. As shown in Table 5, lowering the pH of a formulated paint with acetic acid (a carboxylic acid not unlike those in a HASE thickener) has a beneficial effect of the color acceptance for phthalocyanine blue, but very minor effect for lamp black. Adding ammonia to these paints to return the pH to approximately 9 has only a very minor effect on rub-up and ΔE for the lamp black tinted paint, and is detrimental to both rub-up and ΔE in the phthalocyanine blue tinted paint. These results suggest that the carboxylic acid moieties of a HASE thickener or salts of these may contribute to the improved phthalocyanine blue color acceptance of HASE containing color viscosity stabilized paints but, since the effect is at best minimal for lamp black, this is not as general a solution as the use of a HASE thickener, and particularly, the use of a tristyrylphenol HASE thickener such as RHEOLATE 425.

TABLE 5
Effect of pH on Color Acceptance of RHEOLATE CVS-1-Containing
Optive 130 Paints (T-23957)

| | CVS | | ICI Builder | | | | | |
|---|---|---|---|---|---|---|---|---|
| | Name | [ ] | Name | [ ] | | | Rub-up | Rub-up |
| Sample | (—) | wt. % | (—) | wt. % | pH | Colorant | ΔE | visual |
| 1 | RHEOLATE | 3 | R350¹ | 3.00 | 9.00 | Lamp Black | 2.28 | Significant |
| | CVS-1 | | | | | | | |
| 2 | RHEOLATE | 3 | R350 | 3.00 | 8.58 (acetic acid) | Lamp Black | 2.11 | Significant |
| | CVS-1 | | | | | | | |
| 3 | RHEOLATE | 3 | R350 | 3.00 | 9.12 (ammonia | Lamp Black | 1.76 | Significant |
| | CVS-1 | | | | addition to sample 2 | | | |
| 4 | RHEOLATE | 3 | R350 | 3.00 | 9.00 | Phthalocyanine | 1.86 | Significant |
| | CVS-1 | | | | | Blue | | |
| 5 | RHEOLATE | 3 | R350 | 3.00 | 8.58 (acetic acid) | Phthalocyanine | 1.02 | slight |
| | CVS-1 | | | | | Blue | | |
| 6 | RHEOLATE | 3 | R350 | 3.00 | 9.12 (ammonia | Phthalocyanine | 1.82 | moderate |
| | CVS-1 | | | | addition to sample 5 | Blue | | |

¹R350 is RHEOLATE 350, polyether polyol, a product of Elementis Specialties

The present invention is not to be limited in scope by the specific embodiments disclosed in the examples which are intended as illustrations of a few aspects of the invention and any embodiments which are functionally equivalent are within the scope of this invention. Indeed, various modifications of the invention in addition to those shown and described herein will become apparent to those skilled in the art and are intended to fall within the appended claims.

A number of references have been cited, the entire disclosures of which are incorporated herein by reference.

What is claimed:

1. A water-borne paint system, comprising:
a base paint, comprising
a color viscosity stabilizing compound;
a hydrophobically modified alkali swellable emulsion thickener; and
a colorant.

2. The system of claim 1, wherein the color viscosity stabilizing compound comprises at least one of the following: an ABLBA polymer and an ABCBA polymer.

3. The system of claim 2, wherein said ABLBA polymer comprises an A component comprising a hydrophobic group A; a B component comprising a hydrophilic polymer B; and an L component comprising a linking group.

4. The system of claim 2, wherein the ABLBA polymer comprises: an A component derived from an alcohol including linear C₁₀-C₃₆ alcohols, branched C₁₂-C₃₆ alcohols, cyclic C₁₀-C₃₆ alcohols and mixtures thereof, a B component comprising a polyethylene oxide polymer or a polyethylene oxide-polypropylene oxide copolymer; and an L component selected from one or more of the following linking units: a dianhydride unit, a diisocyanate unit, an ether linkage or other difunctional moiety or difunctional radical having 1 to 22 carbon atoms.

5. The system of claim 4, wherein the hydrophobically modified alkali swellable emulsion thickener comprises the reaction product of vinyl acetate, methacrylate, methacrylic acid and tristyrylphenol polyethoxy ethyl methacrylate.

6. The system of claim 5, wherein the A component is derived one or more of the following: linear C₁₀-C₂₂ alcohols, branched C₁₂-C₂₄ alcohols, cyclic C₁₀-C₂₂ alcohols and mixtures thereof.

7. The system of claim 5, wherein the A component is derived one or more of the following: linear C₁₀-C₁₈ alcohols, branched C₁₂-C₁₈ alcohols, cyclic C₁₀-C₁₈ alcohols and mixtures thereof.

8. The system of claim 5, wherein the A component is derived from one or more of the following: 2-butyl-1-octanol, 2-hexyl-1-decanol, 2-octyl-1-dodecanol, 2-isoheptyl-7-methyl-undecanol, 2-(2,4,4-trimethylbutyl)-6,8,8-trimethyl-nonanol, dodecanol, tetradecanol, hexadecanol, octadecanol, tristyrylphenol, a Geurbet alcohol having an average of 14 carbon atoms and mixtures thereof.

9. The system of claim 6, wherein the polyethylene oxide polymer has from 25 to 100 ethylene oxide repeat units.

10. The system of claim 6, wherein the polyethylene oxide-polypropylene oxide copolymer has a total number of repeat units ranging from 25 to 75 and up to 10 propylene oxide units.

11. The system of claim 10, wherein the polyethylene oxide-polypropylene oxide copolymer has a number average molecular weight less than 4400.

12. The system of claim 4, wherein the linking unit is a diisocyanate linking unit.

13. The system of claim 12, wherein the diisocyanate linking unit is selected from compounds selected from the group consisting of: hexamethylene diisocyanate, trimethyl hexamethylene diisocyanate, isophorone diisocyanate, tetramethyl xylylene diisocyanate, and 4,4-methylene bis(cyclohexylisocyanate).

14. The system of claim 4, wherein the A component is derived from 2-hexyl-1-decanol, the B component is polyethylene oxide having 50 ethylene oxide units and the L component comprises hexamethylene diisocyanate.

15. The system of claim 4, wherein the A component is derived from dodecanol, the B component is polyethylene oxide having 50 to 70 ethylene oxide units and the L component comprises hexamethylene diisocyanate.

16. The system of claim 4, wherein the A component is derived from tetradecanol, the B component comprises polyethylene oxide having 50 to 70 ethylene oxide units and the L component is hexamethylene diisocyanate.

17. The system according to claim 2, wherein the ABCBA polymer comprises an A component comprising a hydrophobic group A, a B component comprising a hydrophilic polymer B, and a C component comprising a hydrophobic low molecular weight difunctional radical C.

18. The system according to claim 17, wherein the ABCBA polymer further comprises an L component linking the B and C components.

19. The system according to claim 18, wherein the ABCBA polymer comprises an A component derived from an alcohol including linear C₁₀-C₃₆ alcohols, branched C₁₂-C₃₆ alcohols, cyclic C₁₀-C₃₆ alcohols and mixtures thereof; a B component comprising a polyethylene oxide polymer or a polyethylene oxide-polypropylene oxide copolymer; a C component selected from the group of diols consisting of hydrophobic low molecular weight linear, branched or cyclic alkyl diols which may also contain O, N, or S heteroatoms; and an L component selected from one or more of the following linking units: a dianhydride unit, a diisocyanate unit, an ether linkage or other difunctional moiety or difunctional radical having 1 to 22 carbon atoms.

20. The system according to claim 18, wherein the ABCBA polymer comprises a B component comprising poly(ethylene glycol), and a C component selected from the group of diols consisting of ethylene glycol, propylene glycol, and 1,2-dodecanediol; and the L component selected from one or more of the following linking units: a dianhydride and a disocyanate unit.

21. The system according to claim 18, wherein the ABCBA polymer comprises, a B component comprising poly(ethylene glycol), and a C component selected from the group of diols consisting poly(tetrahydrofuran), poly(caprolactone) and poly(carbonate); and the L component selected from one or more of the following linking units: a dianhydride and a disocyanate unit.

22. The system according to claim 18, wherein said L linking unit comprise one or more of the following: a urethane linking unit; an ester linking unit; an amide linking unit; a urea linking unit; an ether linkage; or other difunctional moiety or difunctional radical having 1 to 22 carbon atoms.

23. The system according to claim 22, wherein the linking units comprise urethane links obtained from compounds selected from the group consisting of hexamethylene diisocyanate, trimethyl hexamethylene diisocyanate, isophorone diisocyanate, tetramethyl xylylene diisocyanate, and 4,4-methylene bis(cyclohexylisocyanate).

24. The system of claim 2, wherein said base paint comprises a resin.

25. The system of claim 24, wherein the resin comprises one or more of the following: a vinyl acrylic resin, a vinyl acetate ethylene resin, an acrylic resin and a styrene acrylic resin.

26. The system of claim 25, wherein the resin has a particle size greater than 200 nm.

27. The system of claim 25, wherein the resin has a particle size less than 200 nm.

28. The system of claim 2, further comprising at least one associative thickener.

29. The system of claim 28 wherein the at least one associative thickener is at least one condensation polymer associative thickener.

30. The system of claim 28, wherein the at least one associative thickener comprises a mid shear associative thickener.

31. The system of claim 28, wherein the at least one associative thickener comprises a high shear associative thickener.

32. The system of claim 28, wherein the at least one associative thickener comprises a mid shear associative thickener and a high shear associative thickener.

33. The system of claim 2, further comprising a film forming binder resin.

34. The system of claim 33, wherein the film forming binder resin comprises an emulsion resin.

35. The system of claim 33, wherein the film forming binder resin comprises a water dispersible resin.

36. The system of claim 33, wherein the film forming binder resin comprises a water soluble resin.

37. The system of claim 2, further comprising a diluent.

38. The system of claim 2, comprising about 0.05 wt % to about 5 wt % as active polymer of the color viscosity stabilizing compound.

39. The system of claim 1, comprising about 0.02 wt % to about 0.5 wt % as active polymer of the hydrophobically modified alkali swellable emulsion thickener.

40. The system of claim 28, comprising about 0.1 wt % to about 5 wt % of the condensation polymer associative thickener.

41. The system of claim 1, wherein the hydrophobically modified alkali-swellable emulsion thickener is comprised of a tristyrylphenol-containing monomer.

42. A method of improving the color acceptance of color viscosity stabilized latex paints, as measured by rub-ups and/or ΔE values, comprising use of a minor amount of a hydrophobically modified alkali-swellable emulsion thickener in combination with a color viscosity stabilizing additive and, optionally, another associative thickener.

43. The method of claim 42, wherein the hydrophobically modified alkali-swellable emulsion thickener is comprised of a tristyrylphenol-containing monomer.
